(19) United States
(12) Patent Application Publication
(10) Pub. No.: US 2005/0089635 A1
(43) Pub. Date: Apr. 28, 2005

(54) Pattern forming method, conductive thin film, electro-optic device, and electronic equipment

(75) Inventor: Hironori Hasei, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/927,062

(22) Filed: Aug. 27, 2004

(30) Foreign Application Priority Data
Sep. 11, 2003 (JP) 2003-320160

(51) Int. Cl. B05D 5/00

(52) U.S. Cl. 427/256

(57) ABSTRACT

Exemplary embodiments of the present invention provide shortening of the process time when a multi-layered type pattern is formed using a droplet discharging device. Exemplary embodiments provide a pattern forming method that includes: a drawing process whereby a liquid material, in which a pattern forming material composed of fine particles with a film coated dispersed in a disperse medium, is deposited onto a substrate via a droplet discharging device; and a calcination process whereby such liquid material deposited on the substrate is heated to a temperature above than the boiling point of its disperse medium, by repeating such drawing and calcination processes changing a pattern forming material in the drawing process, forming on a substrate a pattern made up of multi-layered film of multiple types of pattern forming materials, and a processing temperature used for the final heating process in the series of repeated calcination processes is above the decomposition temperatures of the film, while the processing temperature for the other calcination processes is above the boiling point of the disperse medium but below the decomposition temperature of the film.

### BACKGROUND OF THE INVENTION

1. Field of Invention

The present invention relates to a method for forming patterns on a substrate using a droplet discharging device.

2. Description of Related Art

Related art Japanese Unexamined Patent Publication No. H7-120611 discloses a method of forming color filter or the like patterns on substrates. This method uses a droplet discharging device (such as an inkjet device). Compared to formation of patterns using photolithography techniques or other coating techniques such as spin coating, this method has the advantages that it involves little waste of the liquid material and readily allows control of the quantity and position of the liquid material deposited on the substrate.

### SUMMARY OF THE INVENTION

Such a droplet discharging technique of the related art is expected to be applied to a method of forming wiring patterns for electronic devices. However, drastically higher levels of integration are being pursued in the field of electronic devices, and correspondingly, patterns are now required to have finer lines. But making the wiring lines finer results in lower adhesion between the pattern and the substrate, and in the case of forming the wire pattern for example, it might result in wiring faults due to peeling of the film or the like. To deal with this and/or other problems a method has been proposed whereby the pattern is formed as multi-layered film, with a film of material having high adhesion with the substrate being used for the bottom most layer.

However, the use of a multi-layered pattern necessitates depositing and calcining a liquid material for each layer, and thus, the process time will increase accordingly.

Exemplary embodiments of the present invention address or resolve the aforementioned and/or other problems. Exemplary embodiments provide a pattern forming method that can permit shortening of the process time when a multi-layered type pattern is formed by using a droplet discharging device, and additionally to provide a conductive thin film that includes a pattern formed by such method, together with an electro-optic device and electronic equipment equipped with such conductive thin film.

In order to address or achieve the above, a pattern forming method of exemplary embodiments of the present invention include a drawing process whereby a liquid material composed of pattern forming material dispersed or dissolved in a disperse medium is deposited onto a substrate via a droplet discharging device; and a heating process whereby the liquid material deposited on the substrate is heated to a temperature above the boiling point of the disperse medium. Repeating such drawing and heating processes changing a pattern forming material in the drawing process, forms on the substrate a pattern made up of multi-layered films of a plurality types of pattern forming materials. The finally implemented heating process employs a high processing temperature.

With this exemplary method, the mid-course heating processes serve as preliminary calcination, while full-fledged calcination is carried out, using the highest temperature, after the final pattern forming material has been deposited, thus executing sintering of a plurality of multi-layered pattern forming material in a single operation.

In pattern forming methods that use droplet discharging techniques, the pattern forming material in the liquid material is sintering via full-fledged calcinations, and enables to fulfill the function of the actual pattern. However, when the plurality of the pattern forming materials are deposited, it is not necessary to completely sinter the lower layer side of pattern forming material prior to the formation of the final pattern forming material. Thus, according to the present method, it is possible to shorten the heating time, or the time required for temperature rise, by using the mid-course heating processes as preliminary calcination and carrying out full-fledged calcination at once in the final heating.

Furthermore, the pattern forming method of exemplary embodiments of the present invention, includes a drawing process whereby a liquid material, in which a pattern forming material composed of fine particles with a film coated is dispersed in a disperse medium, is deposited onto a substrate via a droplet discharging device; and a heating process whereby the liquid material deposited on the substrate is heated to a temperature above the boiling point of its disperse medium. Repeating such drawing and heating processes changing a pattern forming material in the drawing process, forms on the substrate a pattern made up of multi-layered films of a plurality types of pattern forming materials. The processing temperature used for the final heating process in the series of repeated heating processes is above the decomposition temperatures of the film, while the processing temperature for the other heating processes is above the boiling point of the disperse medium but below the decomposition temperature of the film.

With the present exemplary method, the pattern forming materials are not sintered in each of the heating processes, rather, in the mid-course pattern forming stages, merely dry films are created by drying away the disperse medium from the liquid (that is, consist of preliminary calcination), while the final heating process sinters all of the dry films so as to convert them into a completed film (that is, performs full-fledged calcination). Hence, according to the present exemplary method, it is possible to shorten the time taken for the substrate temperature to rise, and the substrate heating time or the like, thus cutting down the overall process time compared to the case where each of the heating processes sinters each of the pattern forming materials.

In the present exemplary method, in the case where the films in the pattern forming materials used in the drawing processes have differing decomposition temperatures, the processing temperature for the final heating process should preferably be higher than the highest of these films decomposition temperatures. This will ensure that all of the dry films are definitively sintered.

Moreover, for a multi-layered type pattern such as described above, that material among the plurality types of the pattern forming materials that has the highest adhesion to the substrate should preferably be deposited closest to the substrate.

By depositing an adhesion-enhancing layer as the first layer (intermediate layers) in this way, a pattern can be formed that has high adhesion to the substrate and so is unlikely to suffer from faults due to peeling or the like.

Such multi-layered type pattern will preferably be a wiring pattern composed of two types of multi-layered films. The pattern forming material of a first layer, deposited at the substrate side, can be fine particles of any one of metals manganese, chromium, nickel, titanium, magnesium, silicon and vanadium, or else fine particles containing oxides of the metals. The pattern forming material of a second layer will preferably be fine particles of any one of the metals gold, silver, copper, palladium and nickel, or else fine particles of an alloy containing the metals. This will permit forming of wiring with high adhesion to the substrate and low resistance.

In advance of the drawing process in the above mentioned exemplary pattern forming method, the regions of the substrate surface other than the pattern forming region should preferably be controlled by surface treatment so that they are repellant to the liquid material that will be used in the drawing process. As used herein, the liquid repellant refers to the property of exhibiting nonaffinity toward the liquid material.

Rendering the substrate surfaces repellant in this way will curb spreading of the liquid material deposited on the substrate, thus permitting the forming of finer lines for the pattern.

The conductive thin film of exemplary embodiments of the present invention include a pattern formed by the exemplary method described above. The electro-optic device of exemplary embodiments of the present invention include the conductive thin film mentioned above. Such electro-optic device could, for example, be a liquid crystal display device, an organic electroluminescence display device, or a plasma display device or the like. The electronic equipment of exemplary embodiments of the present invention include the electro-optic device mentioned above.

According to such configurations, it is possible to provide at low costa conductive thin film, electro-optic device and electronic equipment possessing high-quality patterns.

### BRIEF DESCRIPTION OF THE DRAWINGS

FIG. 1 is a flow diagram showing an example of the pattern forming method of exemplary embodiments of the present invention;

FIGS. 2A-B are schematics showing an example of the procedure for forming the intermediate layer on the substrate;

FIG. 3 is a schematic plan view of a rectilinear line representing one example of a film for the intermediate layer formed on the substrate;

FIG. 4 is a schematic plan view of a discontinuous line representing another example of a film for the intermediate layer formed on the substrate;

FIGS. 5A-C are schematics showing the process of depositing the liquid material on the substrate;

FIG. 6 is a schematic exploded perspective view of a plasma type display device representing a drawing of the electro-optic device of exemplary embodiments of the present invention;

FIG. 7 is a schematic plan view of a liquid crystal device representing a drawing of the electro-optic device of exemplary embodiments of the present invention; and

FIG. 8 is a schematic view of a portable type information processing apparatus equipped with liquid crystal display devices and representing a drawing of the electronic equipment of exemplary embodiments of the present invention.

### DETAILED DESCRIPTION OF PREFERRED EMBODIMENTS

Below is described a method to form conductive film wiring on a substrate which is a example of the pattern forming method of exemplary embodiments of the present invention.

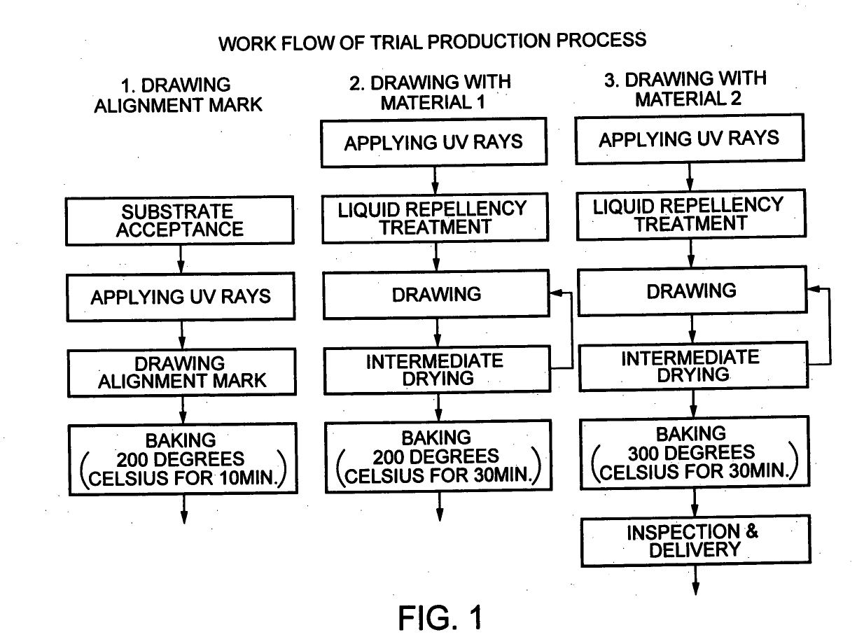

FIG. 1 is a schematic flow diagram showing the processes to form the conductive film wiring of the present exemplary embodiment.

In the wiring forming method of the present exemplary embodiment, a droplet discharging device is used to deposit liquid material onto a substrate so as to form a wiring pattern on the substrate. In this case, in the present exemplary embodiment, in order to achieve high adhesion of the wiring to the substrate, the same pattern is deposited and drawn by a plurality types of liquid materials, and the wiring is formed as the multi-layered film of a plurality types of pattern forming materials (the present exemplary embodiment employs a structure with two layers: an intermediate layer and a conductive layer that constitutes the wiring body part). Thus, the present exemplary wiring forming method includes an intermediate layer forming process and a material depositing process to form the conductive layer that constitutes the wiring body part. Here, the intermediate layer forming process refers to the process forming the intermediate layer that is deposited between the substrate and the wiring body part, and this intermediate layer heightens the adhesion of the wiring body part to the substrate. Together, the intermediate layer and the conductive layer that forms the wiring body part, constitute the conductive thin film (film structure) of exemplary embodiments of the present invention.

Moreover, in the present exemplary embodiment, alignment marks are formed on the substrate in advance of the forming of the wiring pattern so as to reduce or prevent positional offset between the intermediate layer and the wiring body that is formed over it (alignment mark forming process). The forming of these alignment marks is carried out by depositing a liquid material on the substrate using a droplet discharging device, in the same way as for forming of the wiring pattern.

The alignment marks are not only for reducing or preventing positional offset between the multi-layered patterns, but it is also used for example, for positioning and ensuring the levelness of the substrate when the substrate is installed into the droplet discharging device or the like.

First, a description is given here of the liquid materials used in the alignment mark forming process, material depositing process and intermediate layer forming process.

Each of these processes deposits a particular liquid material onto the substrate. Specifically, the material depositing process uses as the pattern forming material, a liquid material containing a first metal fine particles (first liquid material) to form the conductive film wiring, and the intermediate layer forming process uses a liquid material (second liquid material) that is distinct from the first liquid material. Moreover the alignment mark forming method uses as the alignment mark forming material the same pattern forming material as that used in the material depositing process or in the intermediate layer forming process, so as to simplify the operations and reduce or prevent contamination.

To deposit these liquid materials, the droplet discharging method known as the inkjet method is employed, whereby the liquid material is discharged as a droplet through the nozzle of a droplet discharging head.

In the present example described here, the liquid material used in the material depositing process is a disperse liquid in which metal fine particles are dispersed in a disperse medium. The conductive fine particles (first metal fine particles) used here applies either metal fine particles containing any one of silver, gold, copper, palladium and nickel, or of alloy fine particles containing such metal.

The surfaces of the metal fine particles are coated with film of an organic matter or the like (coating material) to enhance their dispersibility.

The particle diameter of the conductive fine particles should preferably be 1 nm or more and 0.1 μm or less. Problems may be caused such as, if they are any larger than 0.1 μm they could cause clogging of the droplet discharging head nozzle. If the particles are smaller than 1 nm their dispersibility will be poor and the coating material will constitute too large a proportion of the volume relative to the metal fine particles, so that the proportion of organic matter in the subsequently obtained film is excessive.

The liquid disperse medium that contains the metal fine particles should preferably be one whose vapor pressure at room temperature is 0.001 mmHg or more and 200 mmHg or less (approximately 0.133 Pa or more and 26600 Pa or less). A disperse medium with vapor pressure higher than 200 mmHg will rapidly vaporize after being discharged, making it difficult to form a film of good quality.

More preferably, the vapor pressure of the disperse medium should be 0.001 mmHg or more and 50 mmHg or less (approximately 0.133 Pa or more 6650 Pa or less). Vapor pressure higher than 50 mmHg will be liable to dry during discharging of the droplet with the inkjet method, causing clogging of the nozzle and making it difficult to obtain a stable jet.

On the other hand, a disperse medium whose vapor pressure is lower than 0.001 mmHg at room temperature will dry slowly and be liable to remain a dispersed medium in the film, which will make it difficult to obtain a conductive film of good quality after the heat treatment and/or light treatment-that is carried out in the calcination (heating) process during the material depositing process.

There is no particular restriction on the disperse medium, provided that it is able to disperse the conductive fine particles and will not permit coagulation. Besides water, the following may be exemplified: alcohols such as methanol, ethanol, propanol and butanol; hydrocarbon based compounds such as n-heptane, n-octane, decane, toluene, xylene, cymene, durene, indene, dipentane, tetrahydronaphthalene, decahydronaphthalene and cyclohexylbenzene; ether based compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether and p-dioxane; and polar compounds such as propylene carbonate, γ-butyrolactone, N-methyl-2-pyrrolidone, dimethylformamide, dimethylsulfoxide and cyclohexanone. Of these, water, the alcohols, the hydrocarbon based compounds and the ether based compounds are preferable regarding ability to disperse the fine particles, stability of the disperse liquid, and suitability to the inkjet method. The water and the hydrocarbon based compounds may be exemplified as particularly preferable disperse media. These cited disperse media might be used either singly or in compounds of two types or more.

The dispersoid concentration of the conductive fine particle when dispersed in the disperse medium will be 1% or more and 80% or less by mass, being adjustable according to the desired thickness of the conductive film. In case the concentration exceeds 80% by mass, coagulation will be liable to occur and consequently it will be difficult to obtain a uniform film.

The surface tension of the conductive fine particles disperse liquid will preferably be within the range 0.02 N/m or more and 0.07 N/m or less. If the surface tension is below 0.02 N/m when the liquid is discharged using the inkjet method, the wettability of a nozzle surface of the ink composition will increase, rendering it likely to occur flight curve. If the surface tension exceeds 0.07 N/m, the meniscus shape at the tip of the nozzle will be unstable, rendering control of the discharge amount and discharge timing problematic.

In order to adjust the surface tension, it will be advisable to add to the disperse liquid a fluorine based, silicone based, and nonionic or the like surface tension regulator, in a minute amount within the range that will not unduly lower the angle of contact with the substrate.

A nonionic surface tension regulator will also serve to enhance the wettability to the substrate of the liquid, enhancing or improving leveling of the film, and reducing or preventing the occurrence of minute irregularities in the film.

It is permissible for the disperse liquid to contain alcohol, ether, ester, ketone or the like organic compounds as necessary.

The viscosity of the disperse liquid will preferably be 1 mPa.s or more and 50 mPa.s or less. When discharged by the inkjet method, if the viscosity is below 1 mPa.s, the periphery part of the nozzle will be liable to become contaminated due to leakage of ink, while viscosity greater than 50 mPa.s will result in a high frequency of clogging of the nozzle opening, rendering smooth discharging of the droplet difficult.

On the other hand, the liquid material used for the intermediate layer forming process in the example here described, is a disperse liquid in which metal fine particles are dispersed in a disperse medium. The metal fine particles (second metal fine particles) used here will have a proven effect of heightening the bonding between the above-described first metal fine particles and the substrate which is created by going through the calcination process, to be described later, during the material depositing process. Such fine particles may be either conductive or nonconductive. It could for example be fine particles containing any one of manganese, copper, chromium, nickel, titanium, magnesium, silicon and vanadium, or an alloy or oxide of such metal. Additionally it is permissible for the liquid material to contain an organic metallic compound of such metal.

The particle diameter of the metal particles used for the intermediate layer forming process should preferably be 1 nm or more and 0.1 μm or less. If they are any larger than 0.1 μm they could cause clogging of the nozzle of the droplet discharging head.

As for the liquid material used for the alignment mark forming process, as mentioned before, the disperse liquid in which the same metal fine particles as the first metal fine particles or the second metal fine particles (alignment mark forming material) are dispersed in a disperse medium, is used.

Since the liquid disperse medium containing metal fine particles that are used for the intermediate layer forming process and alignment mark forming processes can be the same as the metal fine particles disperse medium that is used for the material depositing process, a description of it is omitted here. The same applies to the dispersoid concentration of the fine particles when dispersed in the disperse medium. Likewise, remarks on the surface tension and additives for such fine particles disperse liquid are omitted here as they are the same.

Following are detailed descriptions of each of the above-mentioned exemplary processes.

(Alignment Mark Forming Process)

The alignment mark forming process includes a drawing process whereby liquid material to form conductive film wiring is deposited on the substrate, and a calcination (heating) process whereby the medium (disperse medium) contained in the liquid material deposited on the substrate is dried away.

As the substrate for the conductive film wiring, a variety of items including such as silicon wafer, quartz glass, glass, plastic film and metal plate can be used. Furthermore, a substrate in which a semiconductive film, metallic film, dielectric film, organic film or the like is formed as an underlayer on the surface of such raw substrate can be used as the substrate on which the conductive film wiring is to be formed.

In the drawing process, by moving the droplet discharging head relative to the substrate, liquid material described before containing the alignment mark forming material, is deposited via a droplet discharging head onto the regions of the substrate other than the wiring forming regions. The alignment marks may be of any commonly known shape such as a circle or cross. As necessary, pretreatment such as UV cleaning may be performed on the substrate at this first process.

The calcination process uses heating to remove the disperse medium contained in the liquid material that has been deposited on the substrate, and converting into a dry film. In this process, the heating conditions are such that the disperse medium is completely evaporated thus, there is no need to apply heating until the metal fine particles coating material mentioned above is decomposed. Since, as described later, the alignment marks, the intermediate layer and the conductive layer that will constitute the wiring body part, will all be sintered together in the calcination process during the material depositing process (specifically, will be heated until the coating material is completely decomposed and removed, so that the metal fine particles are caused to contact one another or sinter, thereby converting them into a metal film), it suffices simply to evaporate the disperse medium in the alignment mark forming process. By limiting the calcination processes of the mid-course stages to preliminary calcining in this way, the processing time for the wiring forming process as a whole can be shortened.

Accordingly, the processing temperature of the substrate for this calcination process is set at a level (for example 200° C.) that is higher than the disperse medium boiling point but below the coating material decomposition temperature, and the substrate is heated for 10 minutes or so at such processing temperature.

Such removal of the disperse medium may be carried out via an ordinary heating treatment employing a heating device, for example, such as a hotplate, electric furnace or hot air generator or the like, or alternatively using lamp annealing.

(Intermediate Layer Forming Process)

The intermediate layer forming process includes: a surface treatment process in which those regions of the substrate other than the wiring forming regions, are rendered liquid repellent; a drawing process in which liquid material is deposited on the liquid repellent substrate; an interim drying process in which the liquid material deposited on the substrate is dried at low temperature; and a calcination (heating) process in which the medium contained in the liquid material is dried away by high-temperature heating.

In the surface treatment process the surface of the substrate is processed to make it repellent with regard to the liquid material that will be used in the drawing process. Specifically, surface treatment is executed so that the predetermined contact angle relative to the liquid material will be a value 30 degrees or more and 60 degrees or less. As necessary, pretreatment such as UV cleaning will be performed on the substrate at the surface treatment process.

As methods of controlling the surface's liquid repellence (wettability), one could use, for example, the method of forming a self assembled film on the surface of the substrate, or the plasma treatment method or the like.

The self assembled film forming method involves forming a self assembled film composed of organic molecular film or the like on the surface of the substrate on which the conductive film wiring is to be formed.

The organic molecular film with which the substrate surface is treated will possess a functional group able to bond with the substrate, a lyophilic or liquid-repellent functional group on its opposite side that reforms the nature of the substrate surface (controls its surface energy), and carbon linear chain or partially branched carbon chains that bind together such functional groups. These constituents will bond to the substrate and self-assemble into a molecular film such as a monomolecular film for example.

Here, the self assembled film is a film formed by orienting a compound that is composed of bonding functional groups able to react with the constituent atoms of ground layer or the like, such as the substrate, and of linear chains molecules other than those of such groups, and that possesses extremely high orientability by interactions of the linear chain molecules. Since such self assembled film is formed by orienting the monomoleculars, its thickness can be extremely thin, and it will be uniform at the molecular level. This means that molecules of the same kind will be located on the surface of the film, so that the film surface can be made uniformly and an excellent liquid repellent or lyophilic.

As the highly orientable compound, the use of a fluoroalkylsilane, for example, will result in a self assembled film being formed with each compound oriented so that the fluoroalkyl groups are located on the film surface and the surface is applied with a uniform liquid repellence.

The compound forming the self assembled film could be a fluoroalkylsilane (hereinafter, referred as “FAS”) such as heptadecafluoro-1,1,2,2 tetrahydrodecyl-triethoxysilane, heptadecafluoro-1,1,2,2 tetrahydrodecyl-trimethoxysilane, heptadecafluoro-1,1,2,2 tetrahydrodecyl-trichlorosilane, tridecafluoro-1,1,2,2 tetrahydrooctyl-triethoxysilane, tridecafluoro-1,1,2,2 tetrahydrooctyl-trimethoxysilane, tridecafluoro-1,1,2,2 tetrahydrooctyl-trichlorosilane, or trifluoropropyl-trimethoxysilane. In use, one of these compounds may be used alone, or alternatively two or more of them may be used in combination. The use of FAS will yield adhesion with the substrate and good liquid repellence.

FAS is generally expressed by the structural formula RnSiX₍₄₋ₙ₎, where n is any of the integers 1 or more and 3 or less, X is a hydrolysis group such as methoxy group, ethoxy group, and halogen atoms or the like. Moreover, R is a fluoroalkyl group with the structure (CF₃)(CF₂)x(CH₂)y (where x is any of the integers 0 or more and 10 or less and y is any of the integers 0 or more and 4 or less). And where a plurality of R or X bond with Si, the R or X may be all the same or they may be different respectively. When the hydrolysis group represented by X undergoes hydrolysis it will form silanol, which will react with the hydroxyl groups of the base material of the substrate (glass/silicon) or the like, so that it is bonded to the substrate by siloxane bonds. Meanwhile the R, because it possesses a fluoro group of such as (CF3) on the surface, will alter the properties of the surface of the base material of the substrate or the like, so that it becomes an unwettable surface (low surface energy).

The self assembled film composed of organic molecular film or the like is formed on the substrate by placing the raw-material compound and the substrate in the same hermetically-sealed container and leaving them in the container for 2 to 3 days or so at room temperature. Alternatively the film can be formed on the substrate in 3 hours or so by maintaining the entire hermetically-sealed container at 100° C. The foregoing is forming method by gaseous phase, but it is also possible to form the self assembled film by liquid phase. For example, the self assembled film may be formed on the substrate by immersing the substrate in a solution containing the raw-material compound, then washing and drying the substrate.

Prior to the forming of the self assembled film, pretreatment such as irradiation with ultraviolet rays or cleaning with a solvent should preferably be applied to the substrate surface.

In the plasma treatment method, the plasma irradiation is carried onto the substrate at normal pressure or in a vacuum. A variety of gases may be selected for use in plasma treatment, provided that account is taken of such as the surface material of the substrate on which the conductive wiring is to be formed. The treatment gas could for example be tetrafluoromethane, perfluorohexane, or perfluorodecane or the like.

Additionally, the substrate surface can be processed into being liquid-repellent by pasting a film with the desired liquid repellence, such as polyimide film treated with tetrafluoroethylene for example. Alternatively such polyimide film could itself be used as the substrate.

Moreover, should the substrate surface have higher liquid repellence than desired, it will suffice to perform lyophilic treatment of the substrate surface via irradiation with 170 through 400 nm ultraviolet rays, or exposure of the substrate in an ozone atmosphere, so as to control the surface state.

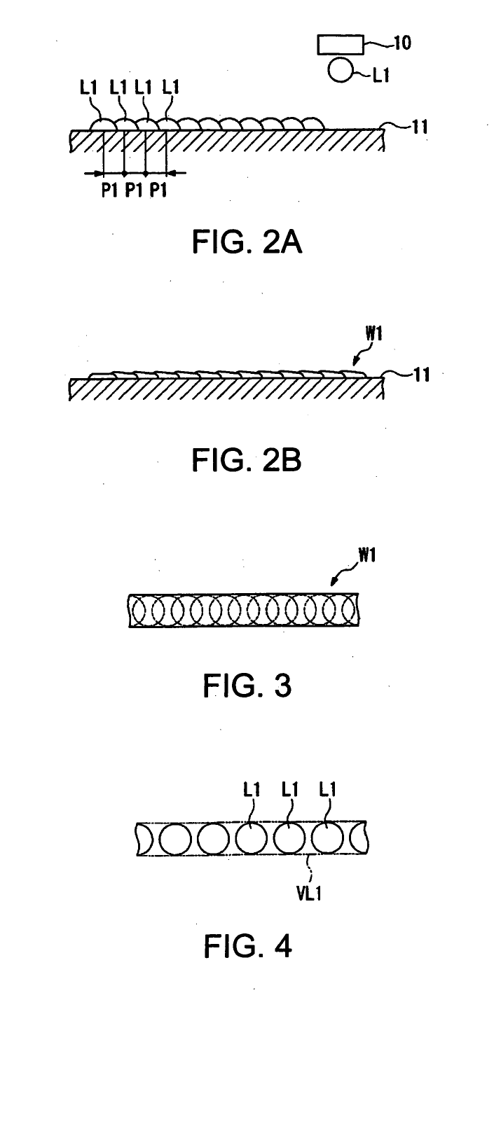

Now the drawing process will be described. FIGS. 2A and 2B show schematically an example of the procedure to form the intermediate layer on the substrate.

As described above, the intermediate layer is to heighten the adhesion of the conductive film wiring with regard to the substrate.

As FIG. 2A shows, in the drawing process, as a droplet discharging head 10 is moved relative to a substrate 11, the liquid material to form the intermediate layer is turned into a droplet L1 and discharged by the droplet discharging head 10, and the droplet L1 is deposited onto the substrate 11 by each constant spacing (pitch P1).

In the present exemplary example, the pitch P1 for arrangement of the droplet L1 is determined so as to be smaller than the diameter of the droplet L1 immediately after it has been deposited on the substrate 11. As a result, after being deposited, the adjacent droplet L1 overlap one another on the substrate 11, forming a continuous line W1. However, the surface treatment is carried out with the substrate 11 at a contact angle of 30 through 60° relative to the liquid material, so that if the adjacent droplet overlap one another to too great an extent, the liquid in the connected line will move readily within the line and form swellings termed bulges, while at its other parts the line will become thinner and breaks in the line will occur. Therefore it is necessary to set the conditions so that the overlapping of the adjacent droplet will amount to 1 through 10% of the diameter of the droplet when it is deposited on the substrate 11.

By executing such droplet depositing operation over the entire substrate surface, a film composed of the predetermined pattern is formed on the substrate 11. The pattern of this film is identical to the wiring pattern for the conductive film wiring.

It is possible, as in the material depositing process to be described later, to make the pitch for deposition of the droplet larger than the diameter of the droplet, immediately after the droplets are deposited on the substrate. In such a case, a continuous line will be formed by repeating deposition of the droplet multiple times for the same location, each time shifting the start point and inserting an interim drying process at the middle.

The droplet discharging conditions, especially the volume of the droplet and the pitch for droplet deposition, are determined so that the edges of the line formed on the substrate 11 are of a good shape with no more than minute irregularities. Since the surface of the substrate 11 has been processed in advance to be liquid repellent, spreading of the droplet deposited on the substrate 11 is curbed.

FIG. 3 is a schematic plan view of a rectilinear line that is one example of a film formed on the substrate to serve as the intermediate layer. As mentioned above, such continuous line W1 can be formed on the substrate 11 by depositing a plurality of droplets successively onto the substrate 11.

The film for the intermediate layer does not have to be a continuous line. For instance it is possible to deposit the droplet L1 spaced apart on a virtual line V1 along which the conductive film wiring is to be formed, so as to form the film for the intermediate layer in a discontinuous form, as shown in FIG. 4.

Further, it is possible for the thickness of the film for the intermediate layer to be thinner than the film for the conductive film wiring described later.

Returning to FIG. 2B, some of the disperse medium contained in the liquid material deposited on the substrate 11 is removed by the interim drying process. This process consists of leaving the substrate for several minutes at room temperature (around 25° C.) or at low heat of several tens of degrees or so, and has the effect of removing the majority of the disperse medium in the liquid material. It is possible to execute such process simultaneously in parallel with the discharging of the liquid material. For example, the substrate could be heated in advance, or cooling of the droplet discharging head could be employed in conjunction with a low boiling point disperse medium, so that the droplet is dried immediately after being deposited on the substrate.

In the calcination process, the substrate is heated to a temperature higher than the processing temperature for the interim drying process, so as to fully remove the disperse medium contained in the liquid material and thus convert it into a dry film. For this process, the heat condition is a condition to sufficiently evaporate the disperse medium, but there is no need to heat to a temperature at which the aforementioned coating material of the metal fine particles would decompose. Since, as described later, the second metal fine particles contained in the intermediate layer will be sintered, together with the first metal fine particles that are formed, by the calcination process during the material depositing process, it is sufficient in the intermediate layer forming process merely to evaporate the disperse medium. This permits the processing time to be shortened.

Thus, in this calcination process the processing temperature of the substrate is heated and set at a level (200° C. for instance) that is higher than the disperse medium boiling point but below the decomposition temperature of the coating material, and the substrate is kept heated at this processing temperature for around 30 minutes. Such removal of the disperse medium may be carried out via an ordinary heating treatment employing a heating means such as a hotplate, electric furnace or hot air generator or the like, or alternatively using lamp annealing.

Thermally treating the substrate at high temperature in this way will return the substrate surface to its condition prior to the surface treatment process. If for instance a FAS film was formed on the substrate in the surface treatment process, such FAS film will be decomposed and removed by heating treatment at around 200° C.

(Material Depositing Process)

The material depositing process includes: a surface treatment process in which the regions of the substrate other than wiring formation regions are rendered liquid repellent; a drawing process in which liquid material is deposited on the liquid repellent substrate; an interim drying process in which the liquid material deposited on the substrate is dried at low temperature; and a calcination (heating) process in which the medium contained in the liquid material is dried away by high-temperature heating.

It is necessary once again to render the substrate surface liquid repellent before the liquid material is drawn because, as mentioned above, the calcination has returned the substrate surface to its state prior to the surface treatment process. A description of such repeat surface treatment process is omitted here since it is the same as the one described before for the intermediate layer forming process. As necessary, pretreatment such as UV cleaning will be performed on the substrate at the time of the surface treatment process.

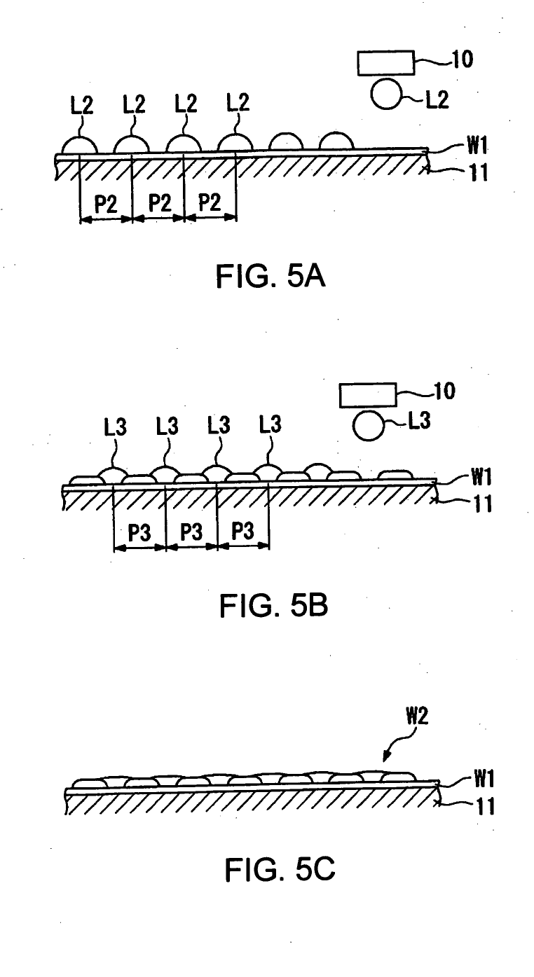

In the drawing process, the droplet discharging head deposits the first liquid material, which will form the wiring body, over film for the intermediate layer that has been formed on the substrate. FIGS. 5A through 5C show in more specific detail the process of depositing the liquid material on the substrate.

Firstly in this drawing process, as shown in FIG. 5A, a droplet L2 discharged from the droplet discharging head 10 is deposited one after another onto the intermediate layer film W1, spaced apart at a constant pitch. In the present exemplary example the depositing pitch P2 for the droplet L2 is determined so as to be greater than the diameter of the droplet L2 immediately after it is deposited on the substrate 11. Moreover, the depositing pitch P2 for the droplet L2 is determined so as to be no more than twice of the diameter of the droplet L2 immediately after it is deposited on the substrate 11.

Next, as shown in FIG. 5B, and putting in between an interim drying process, the above-described droplet deposition operation is repeated. Specifically, in the same way as in the previous operation shown in FIG. 5A, the liquid material is discharged from the droplet discharging head 10 as a droplet L3, which are deposited onto the substrate 11 at a constant spacing.

The volume of the droplet L3 (amount of liquid material per droplet) and its depositing pitch P3 is the same as those for the droplet L2 in the previous operation. Moreover, the positions at which the droplet L3 is deposited are shifted by one half pitch from the positions of the droplet L2 of the previous operation, so that the droplet L3 this time is deposited in between the droplet L2 deposited on the substrate 11 in the previous operation.

As mentioned above, the depositing pitch P2 for the droplet L2 is deposited on the substrate 11 is greater than, but no more than twice, the diameter of the droplet L2 immediately after being deposited on the substrate 11. Because of this, depositing the droplet L3 in between the droplet L2 results in the droplet L3 partially overlapping the droplet L2, so that the gaps between adjacent droplet L2 are filled in. As a result, a continuous line W2 composed of the liquid material for the conductive film wiring is formed over the intermediate layer film W1, as shown in FIG. 5C. By carrying out such droplet depositing operations for the entire substrate surface, a film for the wiring composed of the predetermined pattern will be formed on the substrate 11.

In such case, as mentioned above, because the surface of the substrate 11 has undergone treatment to render it liquid repellent, the liquid material will be repelled by the outside of the intermediate layer film W1, and will be deposited with reliable accuracy on the intermediate layer film W1. Moreover, since the intermediate layer film W1 has a certain degree of resolubility with regard to the disperse medium of the liquid material for the conductive film wiring, it has relatively high affinity toward the liquid material. Because of this, the liquid material deposited on the intermediate layer film W1 will spread well at the inside of the intermediate layer film W1. Furthermore, since as mentioned before, the intermediate layer film W1 is formed in the same pattern as that of the wiring body layer that is formed over it, the liquid material that spreads at the inside of the intermediate layer film W1 will be deposited neatly into the desired wiring pattern.

The interim drying process is implemented after each series of droplet depositing operations. A description of this process is omitted since it is the same one as that described above for the intermediate layer forming process.

Increasing the number of repetitions of the above-described droplet depositing operation will increase the thickness of the film W2, for the conductive film wiring as droplet is successively laid over the substrate 11. This thickness will be determined by the desired thickness required for the ultimately formed conductive film wiring, which in turn will determine the number of repetitions of the droplet depositing operation.

Other conditions such as the depositing pitch of the droplet and the amount of the shift at each repetition can be set to any value desired. The droplet may for example, be discharged so that adjacent droplet partially overlap one another immediately after being discharged, as shown in FIG. 2.

The calcination process uses heat treatment or light treatment to completely remove the disperse medium and coating material contained in the liquid material deposited onto the substrate, and has the additional purpose of bringing the metal fine particles into contact with one another, or sintering them, so as to lower the electrical resistance. In the present exemplary example, the heat treatment of the liquid material for the intermediate layer and the heat treatment of the liquid material for the conductive film wiring are conducted simultaneously.

The calcination process will normally be carried out in the air, but as necessary may be carried out in an atmosphere of inert gas such as nitrogen, argon or helium. The processing temperature for the calcination process will be determined at an appropriate level, taking into account the boiling point (vapor pressure) of the disperse medium, the type and pressure of the atmospheric gas, thermal behavioral properties of the fine particles dispersibility and oxidizability or the like, the existence and volume of the coating material, and the base material heat resistance temperature, or the like.

For example, removal of coating material composed of organic matter will normally require calcination at a temperature of 300° C. or higher. Accordingly in the present exemplary example the heat treatment is implemented by, for example, heating the substrate for around 30 minutes at a temperature of 300° C. or higher which is the decomposition temperature of the coating material. Should the decomposition temperature of the coating material in the pattern forming material used respectively for the drawing process of the above-described intermediate layer forming process and material depositing process differ, the processing temperature for this calcination process should be set at a level at highest of such coating material decomposition temperature.

Besides the commonly-used hotplate, electric furnace or the like treatment methods, this calcination process could alternatively employ lamp annealing. There is no particular restriction on the light source for the light used for lamp annealing. Examples of light sources that could be used are an infrared lamp, xenon lamp, YAG laser, argon laser, carbon dioxide laser, or excimer laser such as XeF, XeCl, XeBr, KrF, KrCl, ArF or ArCl. Such light sources commonly range of 10 W or more and 5000 W or less, but for the present exemplary embodiment the range of 100 W or more and 1000 W or less will be adequate.

By means of the calcination process, electrical contact is secured among the conductive fine particles contained in the liquid material of the film W2 for the conductive film wiring, thereby converting it into a conductive film. At the same time the coating material of the first or second metal fine particles applied in the alignment mark and intermediate layer forming processes are decomposed and removed, so that each of metal fine particles are sintered together and converted into a metallic film. Meanwhile, due to the action of the fine particles contained in liquid material, the film W1 for the intermediate layer enhances the bonding between the conductive fine particles for the conductive film wiring and the substrate 11.

The conductive film wiring formed according to the present exemplary embodiment can be formed with a width that is roughly equal to the diameter of a single droplet of the disperse liquid after landing on the substrate. Moreover, the fact that the metal fine particles contained in the intermediate layer enhance bonding both with the metal fine particles contained in the conductive film wiring and with the substrate, increases the strength of the conductive film wiring adhesion to the substrate.

Thus, according to the present exemplary embodiment, it is possible to form with ease a pattern having good alignment precision and good adhesion with the substrate. More specifically, the fact that the present exemplary embodiment employs the same droplet discharging device to form the alignment marks as to form the pattern means that it yields higher alignment precision, using a simpler method, compared to, for example, cases where the alignment marks are formed by photolithography techniques in related art methods. Especially, this is a major beneficial effect of exemplary embodiments of the present invention, since in cases where the pattern is formed from multi-layered films, such as the present exemplary embodiment, the alignment precision of the multi-layered films with one another is of great importance.

Moreover, the present exemplary embodiment method of using a droplet discharging device to form not only the intended pattern (wiring pattern in the present case) but also ancillary patterns such as alignment marks that are necessary for the manufacture process of the device, enables an entire device to be formed using the liquid discharging technique. Thus the present method is significant in that it constitutes a key technology for switching to all-wet processing of devices.

Furthermore, the present exemplary embodiment can be accomplished in a shorter process time than in cases where the each pattern forming material is sintered in a separate calcination process (i.e. full-fledged calcination). That is, rather than sintering the pattern forming material in each calcination process, it limits the pre-final pattern forming processes merely to drying the disperse medium of the liquid material so as to produce a dry film, then uses the final calcination process to sinter all of the dry films and convert them into the finished film.

Next follows a description of a plasma type display device as an example of the electro-optic device of exemplary embodiments of the present invention.

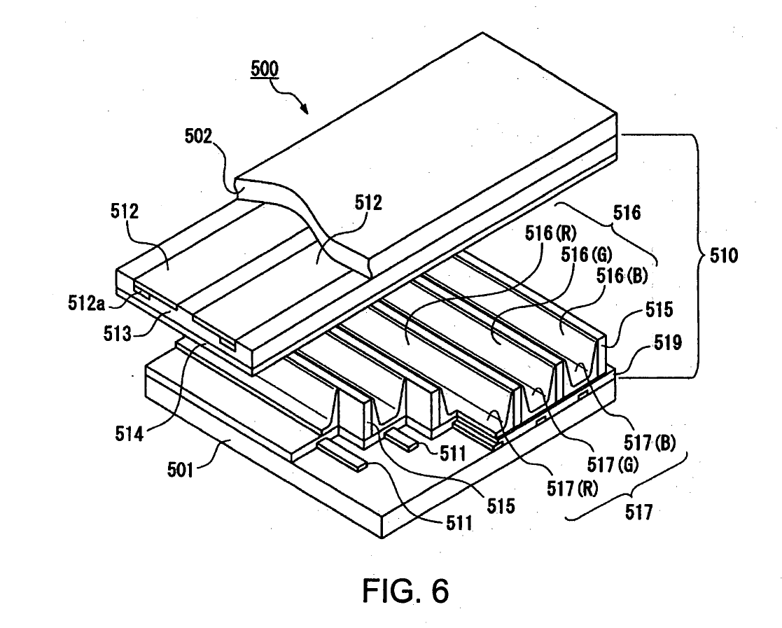

FIG. 6 is a schematic exploded perspective view of a plasma type display device 500 of the present exemplary embodiment. The plasma display type device 500 is composed of glass substrates 501 and 502 arranged facing each other, and an electric discharge display unit 510 interposed between them.

Address electrodes 511 are formed in a stripe shape on the top surface of the glass substrate 501 at a predetermined spacing, and a dielectric layer 519 is formed so as to cover the top surfaces of the address electrodes 511 and the glass substrate 501. On the dielectric layer 519 are formed partition walls 515 that are located between and parallel with the address electrodes 511. Inside the stripe-shape regions delimited by the partition walls 515 are arranged phosphors 517, each of which emits fluorescence of any one of the colors red, green and blue. A red phosphor 517 (R) is arranged on the bottom and sides of a red electric discharge chamber 516 (R), a green phosphor 517 (G) on the bottom and sides of a green electric discharge chamber 516 (G), and a blue phosphor 517 (B) on the bottom and sides of a blue electric discharge chamber 516 (B).

On the other hand, at the glass substrate 502 side, display electrodes 512 composed of a plurality of transparent conductive films are formed in stripe shapes at a predetermined spacing and in a direction orthogonal to the aforementioned address electrodes 511. Additionally, bus electrodes 512a are formed over the display electrodes 512 in order to supplement the display electrodes, which have high resistance. A dielectric layer 513 is formed so as to cover these items, and over that is formed a protective film 514 composed of MgO or the like.

The glass substrates 501 and 502 are bonded together facing each other in such a manner that the address electrodes 511 and the display electrodes 512 cross each other orthogonally.

The electric discharge display unit 510 is a grouping of a plurality of electric discharge chambers 516. It is arranged so that one pixel is configured by a set of the red electric discharge chamber 516 (R), the green electric discharge chamber 516 (G) and the blue electric discharge chamber 516 (B) among the a plurality of electric discharge chambers 516, and a region enclosed by a pair of display electrodes.

The address electrodes 511 and display electrodes 512 are connected to an alternating current power supply which is omitted from the drawings. A color display can be produced by supplying power to the various electrodes, so that the phosphors 517 in the plasma display unit 510 become excited and emit light.

In the present exemplary embodiment the bus electrodes 512a and address electrodes 511 are formed using the forming method for the conductive film wiring that was shown in FIG. 1. Because of this the adhesion of the bus electrodes 512a and address electrodes 511 is strong and wiring faults are unlikely to occur. Further, since the wiring can be aligned with high precision, it is possible to make the wires high-density. And because forming of the alignment marks employs the droplet discharging device, for example, the process is simpler, and the device costs can be curbed, compared to the case where such forming employs a technique such as photolithography.

Should the intermediate layer be composed of a manganese compound (oxide of manganese), then despite the fact that manganese oxides are nonconductive, the necessary conductivity between the display electrodes 512 and the bus electrodes 512a can be assured by making the manganese layer extremely thin and making it porous. In such a case the intermediate layer will be black and therefore will exert a black matrix-like effect that will permit an enhanced display contrast.

There now follows a description of a liquid crystal device as another example of the electro-optic device of exemplary embodiments of the present invention.

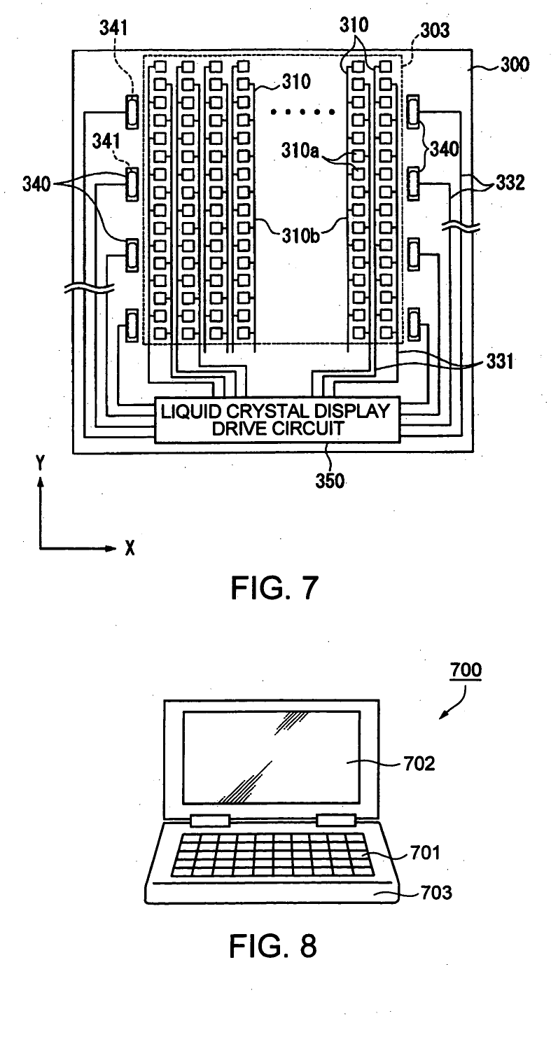

FIG. 7 is a schematic showing the plan layout of the signal electrodes or the like on a substrate 300 of the liquid crystal device in the present exemplary embodiment. The liquid crystal device in the present exemplary embodiment is schematically structured of the first substrate 300, a second substrate (not shown) which is provided with scanning electrodes or the like, and liquid crystal (not shown) which is sealed between the first and second substrates.

As FIG. 7 shows, in a pixel domain 303 on the first substrate 300 there is provided a plurality of signal electrodes 310 in a multiplex matrix arrangement. Especially, each of the signal electrodes 310 is composed of a plurality of pixel electrode parts 310a, in which each signal electrodes 310 corresponds to a pixel, and signal wiring parts 310b which connect up the pixel electrode parts 310a in a multiplex matrix arrangement and is extended in the Y direction.

Reference numeral 350 indicates chip-structure liquid crystal drive circuit. The end sides (lower sides as seen in the drawing) of the signal wiring parts 310b are connected to the liquid crystal drive circuit 350 via first lead wires 331.

Reference numeral 340 indicates vertical conducting terminals, which are connected via vertical conductors 341 to terminals provided on the second substrate not shown. Additionally, the vertical conducting terminals 340 are connected to the liquid crystal drive circuits 350 via second lead wires 332.

In the present exemplary embodiment, the signal wiring parts 310b, the first lead wires 331 and the second lead wires 332 provided on the first substrate 300, are all formed according to the forming method for the conductive film wiring shown in FIG. 1. As a result, this wiring has high adhesion and is unlikely to suffer from wiring faults. Further, since the wiring can be aligned with high precision, it is possible to make the wires high-density. And because forming of the alignment marks employs a droplet discharging device, the process is simpler, and the device costs can be curbed, compared to the case where such forming employs a technique such as photolithography.

The devices to which exemplary embodiments of the present invention can be applied are by no means limited to the foregoing electro-optic devices. It can also be applied to the manufacture of a variety of other devices such as, for example, circuit boards with conductive film wiring formed on them, and semiconductor packaged wiring.

Next is described a specific example of the electronic equipment of exemplary embodiments of the present invention.

FIG. 8 is a schematic perspective view of one example of a portable type information processing apparatus such as a word processor or personal computer. In FIG. 8, 700 is an information processing apparatus, 701 is input unit such as a keyboard, 703 is a information processing main body, and 702 is a liquid crystal display unit equipped with the liquid crystal device shown in FIG. 7.

Because the electronic equipment shown in FIG. 8 is equipped with the liquid crystal device of the exemplary embodiment as described above, its wiring has high adhesion and it is unlikely to suffer from wiring faults. Furthermore, such electronic equipment can be supplied at low cost.

The electronic equipment of the present exemplary embodiment is equipped with a liquid crystal device, but alternatively it could be equipped with another electro-optic device such as an organic electroluminescence display device or a plasma type display device.

Above, a preferred exemplary embodiment of the present invention has been described with reference to the appended drawings. The present invention is however by no means limited to the foregoing exemplary embodiments and can be implemented in many different variations without departing from its spirit.

For example, in the foregoing exemplary embodiments the alignment mark forming process was separated from the pattern forming processes (intermediate layer forming and material depositing processes), but it could be implemented as a part of the intermediate layer forming process. Specifically, when the second liquid material is applied and drawn to the substrate during the intermediate layer forming process, the alignment marks could be drawn at the same time. In such a case, the alignment marks would be used as a positioning device for accurate deposition of the first liquid material on the intermediate layer during the subsequent material depositing process.

Moreover, although the foregoing exemplary embodiment employed a two-layer structure for the wiring pattern, including an intermediate layer plus a conductive layer that constituted the wiring body, the wiring pattern may equally well consist of a single-layered film or a multi-layered film with three or more layers. In the case where the pattern is a multi-layered film with three or more layers, the film layer with the highest adhesion will preferably be deposited as the first layer (that is, the one closest to the substrate). This will heighten the strength of the adhesion between the substrate and the pattern, rendering faults due to peeling or the like unlikely to occur.

Should a pattern composed of a multi-layered film with three or more layers be formed by ways of the foregoing exemplary embodiment, it will be advisable to form the alignment marks using the droplet discharging device in advance of forming of the first layer and second layer films. Particularly in the case where such as positioning of the substrate when it is installed in the droplet discharging device is not necessary, the alignment marks may be formed after or simultaneously with forming of the first layer (that is, before forming of the second layer). Especially where the material used to form the alignment marks is the same as the pattern forming material for the first layer, and forming process of the alignment marks is carried out in the same process as forming of the first layer, this will simplify the processes and make for easier operations, besides also reducing or preventing contamination.

Moreover, although the foregoing exemplary embodiment used a wiring pattern as an illustrative example of a pattern to which the present-invention applies, the present invention is by no means limited to such a pattern and can equally well be applied to the forming of other patterns than wiring patterns.

Furthermore, the various shapes and combinations or the like, of each component members described in the-foregoing exemplary embodiment represent mere examples and are capable of being varied in many different ways in accordance with design requirements or the like, without departing from the spirit of the exemplary embodiments of the present invention.

1. A pattern forming method, comprising:
depositing a liquid material, composed of pattern forming material that is at least one of dispersed and dissolved in a disperse medium, onto a substrate via a droplet discharging device;
heating the liquid material deposited on the substrate to a temperature above a boiling point of the disperse medium;
repeating the depositing and heating processes;
changing a pattern forming material in the depositing process;
forming on the substrate, a pattern made up of multi-layered films of a plurality types of pattern forming materials; and
employing a highest processing temperature for finally implemented heating process.

2. A pattern forming method, comprising:
depositing a liquid material, in which a pattern forming material composed of fine particles with a film coated dispersed in a disperse medium, onto a substrate via a droplet discharging device;
heating the liquid material deposited on the substrate, to a temperature above a boiling point of the disperse medium;
repeating the depositing and heating processes;
changing a pattern forming material in the depositing process;
forming on the substrate, a pattern made up of multi-layered films of a plurality types of pattern forming materials;
employing a processing temperature used for the final heating process in the series of repeated heating processes, above a decomposition temperatures of the film; and
employing a processing temperature for the other heating processes above the boiling point of the disperse medium but below a decomposition temperature of the film.

3. The pattern forming method according to claim 1, further comprising:
depositing closest to the substrate, a material, among a plurality types of pattern forming materials, that has a highest adhesion to the substrate.

4. The pattern forming method according to claim 1, further comprising:
composing a wiring pattern of two types of multi-layered films, the pattern forming material of a first layer, deposited of the substrate side, being fine particles of any one of metals manganese, chromium, nickel, titanium, magnesium, silicon and vanadium, or else fine particles containing oxides of the metals, and the pattern forming material of a second layer being fine particles of any one of the metals gold, silver, copper, palladium and nickel, or else fine particles of an alloy containing the metals.

5. The pattern forming method according to claim 1, further comprising:
controlling in advance of the drawing process, a region of the substrate surface other than the pattern forming region, by surface treatment so that the region is repellant to the liquid material that will be used in the depositing process.

6. A conductive thin film, comprising:
a pattern formed according to the method of claim 1.

7. An electro-optic device, comprising:
the conductive thin film according to claim 6.

8. Electronic equipment, comprising:
the electro-optic device according to claim 7.
